(19) United States
(12) Patent Application Publication
(10) Pub. No.: US 2025/0362681 A1
(43) Pub. Date: Nov. 27, 2025

(54) MAP DATA MANAGEMENT METHOD, DEVICE AND COMPUTER-READABLE STORAGE MEDIUM

(71) Applicant: Ubtech Robotics Corp Ltd, Shenzhen (CN)

(72) Inventors: YU TANG, Shenzhen (CN); Zhanjia Bi, Shenzhen (CN); Jichao Jiao, Shenzhen (CN)

(21) Appl. No.: 19/294,163

(22) Filed: Aug. 7, 2025

Related U.S. Application Data
(63) Continuation of application No. PCT/CN2023/141735, filed on Dec. 26, 2023.

(30) Foreign Application Priority Data
Apr. 7, 2023 (CN) 202310413614.1

(51) Int. Cl. G05D 1/246; G05D 109/10; G06F 16/29

(52) U.S. Cl. CPC G05D 1/246; G06F 16/29; G05D 2109/10

(57) ABSTRACT

A map data management method includes: during map construction by a device, acquiring environmental data collected when the device is at different target locations; determining first key data corresponding to the environmental data; acquiring a current first location of the device, and determining a second location based on the first location, wherein the first location is one of the target locations, and the second location is a location among the target locations other than the first location, and a predetermined condition is satisfied between the second location and the first location; and based on the second location, determining second key data from the first key data, and storing the second key data in a preset database.

### CROSS REFERENCE TO RELATED APPLICATIONS

The present application is a continuation-application of International Application PCT/CN2023/141735, with an international filing date of Dec. 26, 2023, which claims foreign priority to Chinese Patent Application No. 202310413614.1, filed on Apr. 7, 2023, in the China National Intellectual Property Administration, the contents of all of which are hereby incorporated by reference in its entirety.

### TECHNICAL FIELD

The present disclosure generally relates to mapping technologies, and in particular, relates to a map data management method, device, and computer-readable storage medium.

### BACKGROUND

Simultaneous localization and mapping (SLAM) is a key technology for autonomous devices (e.g., robots, vehicles, and autonomous smart home devices) and can be applied in fields such as autonomous driving and high-precision map reconstruction. When the autonomous devices use SLAM technology for large-scale mapping, they need to acquire vast amounts of laser data, image data, inertial measurement unit (IMU) data, and other information to construct maps. This process consumes significant memory resources of the autonomous devices, resulting in higher hardware requirements—specifically, the need for autonomous devices to have larger memory capacity.

Therefore, there is a need to provide a map data management method to overcome the above-mentioned problem.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram of a device according to one embodiment.

FIG. 2 is an exemplary flowchart of a map data management method according to one embodiment.

FIG. 3 is a schematic diagram of a predetermined route.

FIG. 4 is a schematic diagram of an application scenario according to one embodiment.

FIG. 5 is a schematic diagram of an application scenario according to another embodiment.

FIG. 6 shows a block diagram of a map data management device according to one embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

Simultaneous localization and mapping (SLAM) is a key technology for autonomous devices (e.g., robots, vehicles, and autonomous smart home devices) and can be applied in fields such as autonomous driving and high-precision map reconstruction. When the autonomous devices use SLAM technology for large-scale mapping, they need to acquire vast amounts of laser data, image data, inertial measurement unit (IMU) data, and other information to construct maps. This process consumes significant memory resources of the autonomous devices, resulting in higher hardware requirements—specifically, the need for autonomous devices to have larger memory capacity.

To address the above issues, embodiments of the present disclosure provide a map data management method, a device, and a computer-readable storage medium. The method may include: during map construction by a device, acquiring environmental data collected when the device is at different target locations; determining first key data corresponding to the environmental data; acquiring a current first location of the device, and determining a second location based on the first location, wherein the first location is one of the target locations, and the second location is a location among the target locations other than the first location, and a predetermined condition is satisfied between the second location and the first location; and based on the second location, determining second key data from the first key data, and storing the second key data in a preset database. According to the method, during map construction, the device can determine a second location based on its current first location and then obtains the second key data based on the second location and store it in the preset database. This approach reduces memory resource consumption on the device, lowers hardware requirements, enhances the device's applicability, and improves usability and practicality.

The map data management method described in the embodiments of the present disclosure can be applied to devices capable of map construction, including but not limited to robots, mobile phones, tablet computers, wearable devices, in-vehicle devices, augmented reality (AR)/virtual reality (VR) devices, laptop computers, ultra-mobile personal computers (UMPCs), netbooks, and personal digital assistants (PDAs). The embodiments of the present disclosure do not impose any restrictions on the specific type of device.

The following explains the key terms used in the embodiments of the present disclosure. A spatial database refers to the collection of application-related geospatial data stored by a geographic information system (GIS) on a physical computer storage media. This data is typically organized in the form of a series of files with a specific structure. In other words, a spatial database is a collection of data related to spatial geography within a specific area of the Earth's surface, reflecting information on a specific subject. It is a specialized database that stores spatial objects and is the core of a GIS. Spatial databases facilitate the management and maintenance of spatial data.

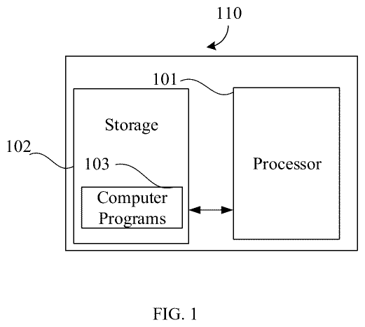

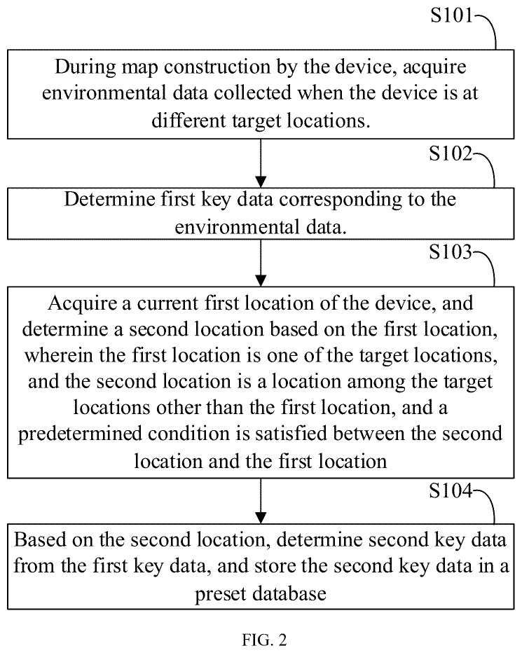

FIG. 1 is a schematic block diagram of a device 110 according to one embodiment. In one embodiment, the device 110 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of a map data management method, such as steps S101 to S104 in FIG. 2 are implemented.

The processor 101 may be an integrated circuit chip with signal processing capability. The processor 101 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the device 110, such as a hard disk or a memory. The storage 102 may be an external storage device of the device 110, such as a plug-in hard disk, a smart memory card (SMC), and a secure digital (SD) card, or any suitable flash cards. Furthermore, the storage 102 may include both an internal storage unit and an external storage device. The storage 102 is to store computer programs, other programs, and data required by the device 110. The storage 102 can be used to temporarily store data that has been output or is about to be output. Upon receiving an execution instruction, the processor 101 can correspondingly execute the computer program stored on the storage 102.

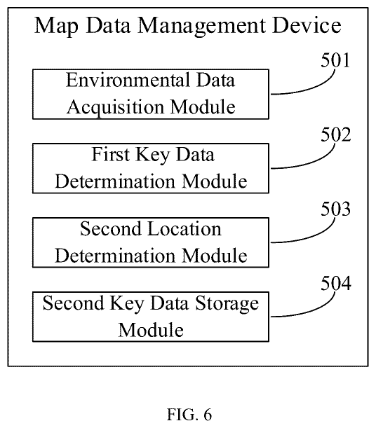

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the device 110. For example, the one or more computer programs 103 may be divided into an environmental data acquisition module 501, a first key data determination module 502, a second location determination module 503, and a second key data storage module 504 as shown in FIG. 6.

It should be noted that the block diagram shown in FIG. 1 is only an example of the robot control device. The robot control device may include more or fewer components than what is shown in FIG. 1, or have a different configuration than what is shown in FIG. 1. Each component shown in FIG. 1 may be implemented in hardware, software, or a combination thereof.

FIG. 2 is an exemplary flowchart of a map data management method according to one embodiment. As an example, but not a limitation, the method can be implemented by the device 110. The method may include steps S101 to S104.

Step S101: During map construction by the device 110, acquire environmental data collected when the device is at different target locations.

Step S102: Determine first key data corresponding to the environmental data.

Step S103: Acquire a current first location of the device, and determine a second location based on the first location, wherein the first location is one of the target locations, and the second location is a location among the target locations other than the first location, and a predetermined condition is satisfied between the second location and the first location.

Step S104: Based on the second location, determine second key data from the first key data, and store the second key data in a preset database.

Here, the environmental data may be one or more of laser data, image data, IMU data, point cloud data, and global positioning system (GPS) data. The first key data may be one or more of keyframes, landmark data, and global navigation satellite system (GNSS) data. The following description will use a keyframe as the first key data for example.

It should be noted that when map construction is required for a specific area, the device 110 can move within the area along a predetermined route and, during this movement, collect environmental data surrounding the device's locations (i.e., the target locations). For example, the device 110 can be equipped with one or more cameras. Therefore, as the device 110 moves within the area along a predetermined route, the device 110 can use the one or more cameras to collect image data surrounding the device's locations. In another example, the device 110 can be equipped with a lidar. Therefore, as the device 110 moves within the area along a predetermined route, the device 110 can use the lidar to collect laser data surrounding the device's locations. In yet another example, the device 110 can be equipped with one or more IMUs. Therefore, as the device 110 moves within the area along a predetermined route, the device 110 can use the one or more IMUs to collect IMU data surrounding the device's locations.

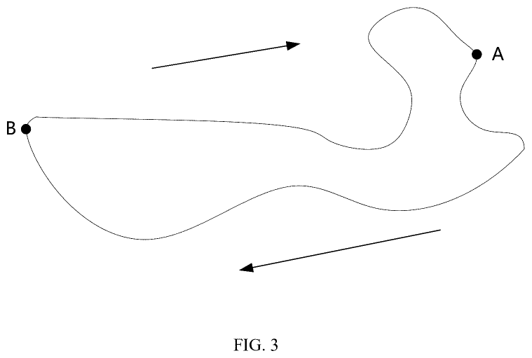

In one embodiment, the predetermined route can be pre-set by a user or determined in real time by the device 110 itself based on actual conditions. For example, when map construction is required for a specific area, the user can pre-set the predetermined route shown in FIG. 3, where both the starting point and end point of the predetermined route can be location A, and the movement direction along the predetermined route can be shown by the arrows in FIG. 3. Therefore, when the device 10 performs map construction for the area, it can move within the area along the route from location A to location B and then from location B back to location A.

Exemplarily, after obtaining environmental data corresponding to the target locations, the device 110 can determine the first key data corresponding to the environmental data. Exemplarily, the device 110 can determine the first key data corresponding to the environmental data based on at least one of movement distance, movement time, and rotation angle. For example, the device 110 can determine a keyframe every time it moves 1 meter, rotates 30 degrees, or moves for 5 seconds. That is, while the device 110 is moving, it can obtain at least one of the movement distance, movement time, and rotation angle corresponding to the device 110 in real time, and can determine keyframes based on at least one of the movement distance, movement time, and rotation angle.

It should be noted that the above-mentioned method of determining keyframes is only explained as an example and should not be understood as a limitation to the embodiments of the present disclosure. In another embodiment, keyframes can be determined according to other conventional methods.

In one embodiment, when constructing a map, the device 110 can continuously obtain its current location in real time, referred to as the first location, and can determine a second location based on the first location and a preset condition, so that the second key data can be determined from the first key data based on the second location, and the second key data can be stored in a preset database. That is, there is no need to store all the data in the memory of the device 110, which can reduce the device's memory occupancy.

In one embodiment, the second key data may be one or more keyframes in the second location, or may be one or more keyframes in the vicinity of the second location. That is, the device 110 may determine the one or more keyframes at the second location or in the vicinity of the second location from the first key data, and may determine one or more keyframes at the second location or in the vicinity of the second location as the second key data and store them in the preset database.

It should be understood that the vicinity of the second location can be determined based on a specified distance threshold—that is, any location within this threshold distance from the second location is considered to be in the vicinity of the second location. The specified distance threshold can be defined according to the actual scenario, and no limitations are imposed in the present disclosure regarding its specific value. For example, the specified distance threshold may be defined as the distance of 20 keyframes, meaning the vicinity of the second location refers to a location whose distance from the second location is less than 20 keyframes.

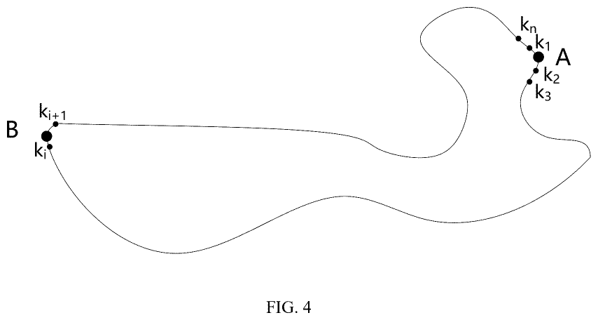

FIG. 4 shows a schematic diagram of an application scenario according to one embodiment. In this application scenario, the second key data is exemplified as keyframes located in the vicinity of the second location, with the specified distance threshold set to 20 keyframes.

As shown in FIG. 4, when mapping an area, the device 110 can move within the area along a route from location A to location B and then back from location B to location A. During this movement, the device 110 can acquire environmental data at each target location and generate a series of keyframes Ki (i=1, . . . , n). For illustration purposes, only a portion of the keyframes is shown in FIG. 4. In addition, during this movement, the device 110 can acquire its current first location in real time. Assume the device 110 is currently at location B. Subsequently, the device 110 can determine a second location based on location B and a preset condition. Assume the second location includes location A. Therefore, the device 110 can acquire keyframes in the vicinity of location A and store them in a preset database. Assume the keyframes in the vicinity of location A include K₁, K₂, K₃, K₄, K₅, K₆, K₇, K₈, . . . , K₂₀. The device can store keyframes K₁, K₂, K₃, K₄, K₅, K₆, K₇, K₈, . . . , K₂₀ in the preset database.

In one embodiment, the preset condition may be a distance-based condition. For example, the preset condition may be that the distance between the first location and the second location is greater than a preset distance threshold. That is, after obtaining the first location, the device 110 may obtain the distance between each target location other than the first location and the first location, and may determine those target locations whose distance from the first location exceeds the predefined threshold as second locations. In other words, the device's memory may only store key data in the vicinity of the device's current location, while key data corresponding to other locations may be stored in a preset database, thereby reducing the device's memory usage and improving the overall performance of the device.

It should be noted that the preset distance threshold can be determined based on actual circumstances, and the embodiments of the present disclosure impose no limitation thereto. For example, the preset distance threshold can be set to a distance of 20 keyframes. This means that only the 20 keyframes closest to the device's current location can be stored in the device's memory, while the remaining keyframes can be stored in a preset database. This reduces the consumption of the device's memory and improves the device's performance.

In another embodiment, the preset condition can be a time-based condition. For example, the preset condition can be that the interval between the time the device 110 arrives at the first location (hereinafter referred to as the first time) and the time the device 110 arrives at the second location (hereinafter referred to as the second time) is greater than a preset time threshold. That is, when the device 110 arrives at each target location, the arrival time can be recorded. When obtaining the device's current first location, the device can obtain the first time corresponding to the first location and the second time corresponding to each target location other than the first location. Then, the device 110 can then determine the interval between the first time and each second time and identify the target locations corresponding to the intervals greater than the preset time threshold as second locations. In other words, the device's memory can only store critical data close to the current time, while critical data corresponding to other times can be stored in a preset database, thereby reducing the device's memory usage and improving the device's performance.

It should be noted that the preset time threshold can be determined based on actual circumstances, and the present disclosure does not impose any restrictions on this. For example, the preset time threshold can be set to one minute. That is, the device may store only the keyframes generated within the most recent one minute in its memory, while other keyframes can be stored in a preset database, thereby reducing memory consumption.

In one embodiment, the preset database may be a spatial database. That is, the device 110 may store the second key data in the spatial database based on the spatial location relationship of the data to facilitate management of the second key data. It should be understood that the spatial database may be located within the device or on a cloud server or other device that is in communication with the device.

In one embodiment, when storing the second key data in the spatial database, the second key data can be divided into multiple modules using a preset classification method for storage. For example, the second key data can be divided based on point cloud coordinates, and the second key data can be stored by partitioning the constructed map. This facilitates rapid retrieval of the second key data from the spatial database based on the current location of the device, allowing for efficient map loading.

In one embodiment, when storing the second key data in the spatial database, the device 110 can serialize the second key data and store the serialized second key data in the spatial database. When it is necessary to obtain certain second key data, the serialized second key data can be obtained from the spatial database and then deserialize it to recover the original second key data. This approach can accelerate data writing and reading processes, thereby enhancing the user experience.

For example, when the second key data is a point with coordinates P(x, y, z), the coordinates of this point can be serialized into binary data and stored in the spatial database. When the data corresponding to this point needs to be read, the binary data can be retrieved from the spatial database and deserialized to obtain the point's coordinates.

In one embodiment, after the second key data is stored in the preset database, if it is detected that the device 110 is located at the second location—i.e., the device has returned to the second location—the device may determine third key data from the second key data and retrieve the third key data from the preset database. Based on the third key data, the device can then generate a local map corresponding to the second location. In other words, when the device revisits the second location, it can retrieve the third key data in the vicinity of the second location from the preset database and load the local map according to the third key data, without needing to load the entire map. This improves map loading speed and reduces memory consumption on the device.

In one embodiment, the third key data may be the key data in the vicinity of the second location, with the second location as the center. It should be understood that the size of the vicinity can be determined according to the actual scenario, and no specific limitation is imposed in the present disclosure. For example, the vicinity may be defined as a 3×3 grid (nine-grid layout), meaning that the third key data includes the key data corresponding to the 3×3 grid centered on the second location. To improve matching accuracy, the size of the vicinity may also be a 4×4 grid (16-grid layout) or a 5×5 grid (25-grid layout), meaning that the third key data includes the key data corresponding to a 4×4 or 5×5 grid centered on the second location.

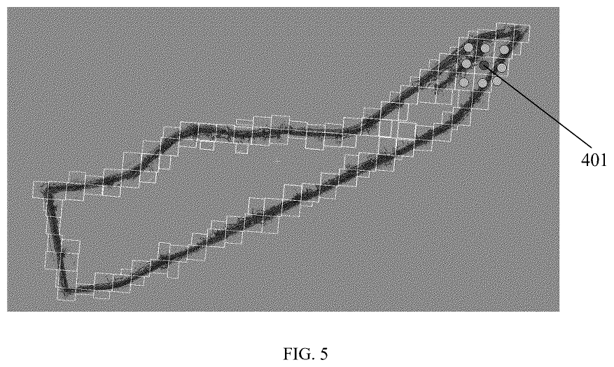

FIG. 5 shows a schematic diagram of an application scenario according to another embodiment. This application scenario is exemplified using the case where the third key data includes the key data corresponding to a 3×3 grid (nine-grid layout) centered on the second location.

As shown in FIG. 5, when the device needs to perform positioning or repositioning, it may acquire its initial location 401. The initial location may be a location (e.g., a GNSS location) provided by another device or may be manually entered by the user. Subsequently, as illustrated in FIG. 5, the device can determine the third key data surrounding the initial location 401—that is, the key data corresponding to a 3×3 grid centered on the initial location 401 (i.e., the key data corresponding to the nine points shown in FIG. 5). These nine-grid key data can then be loaded from the preset database into the memory of the device, enabling the generation of a local map around the initial location 401. When the location of the device changes, the device can reload new key data from the preset database into its memory according to the updated location to generate a local map corresponding to the updated location. That is, the device can load a local map according to its current location without loading the entire map, which can improve the map loading speed and reduce the memory consumption of the device.

In summary, by implementing the map data management method described in the aforementioned embodiments, the device 110 can perform the following operations: acquiring environmental data collected when the device is at different target locations during map construction; determining first key data corresponding to the environmental data; acquiring a current first location of the device, and determining a second location based on the first location, wherein the first location is one of the target locations, and the second location is a location among the target locations other than the first location, and a predetermined condition is satisfied between the second location and the first location; and based on the second location, determining second key data from the first key data, and storing the second key data in a preset database. Therefore, during map construction, the device can determine a second location based on its current first location and then obtains the second key data based on the second location and store it in the preset database. This approach reduces memory resource consumption on the device, lowers hardware requirements, enhances the device's applicability, and improves usability and practicality.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

Corresponding to the map data management method described in the aforementioned embodiments, FIG. 6 shows a block diagram of a map data management device according to one embodiment. As an example and not by way of limitation, the map data management device can be applied to the device 110. For ease of illustration, only the portion relevant to the embodiment of the present disclosure is shown.

As shown in FIG. 6, the map data management device may include an environmental data acquisition module 501, a first key data determination module 502, a second location determination module 503, and a second key data storage module 504. The environmental data acquisition module 501 is to acquire environmental data collected when the device is at different target locations during map construction by the device 110. The first key data determination module 502 is to determine first key data corresponding to the environmental data. The second location determination module 503 is to acquire a current first location of the device, and determine a second location based on the first location. The first location is one of the target locations, and the second location is a location among the target locations other than the first location. A predetermined condition is satisfied between the second location and the first location. The second key data storage module 504 is to, based on the second location, determine second key data from the first key data, and store the second key data in a preset database.

In one embodiment, the preset database is a spatial database.

In one embodiment, the second key data storage module 504 is further to serialize the second key data and store the serialized second key data in the preset database.

In one embodiment, the first key data determination module 502 is further to obtain at least one of a movement distance, a movement time, and a rotation angle corresponding to the device, and determine the first key data corresponding to the environmental data based on at least one of the movement distance, the movement time, and the rotation angle.

In one embodiment, the second location determination module 503 is further to obtain a distance between each of the target locations, except the first location, and the first location; and determine one of the target locations whose distance from the first location is greater than a preset threshold as the second location.

In another embodiment, the second location determination module 503 is further to: obtain a first time and a number of second times, wherein the first time is a time when the device arrives at the first location, and the second times are times when the device arrives at the target locations other than the first location; and determine an interval between each of the second times and the first time, and determine one of the target locations corresponding to one of the intervals greater a preset threshold as the second location.

In one embodiment, the map data management device may further include a third key data determination module and a third key data acquisition module. The third key data determination module is to determine third key data from the second key data when the device 110 is detected to be at the second location. The third key data acquisition module is to obtain the third key data from the preset database, and generate a local map corresponding to the second location based on the third key data.

It should be noted that content such as information exchange between the modules/units and the execution processes thereof is based on the same idea as the method embodiments of the present disclosure, and produces the same technical effects as the method embodiments of the present disclosure. For the specific content, refer to the foregoing description in the method embodiments of the present disclosure. Details are not described herein again.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. In addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented map data management method, the method comprising:
during map construction by a device, acquiring environmental data collected when the device is at different target locations;
determining first key data corresponding to the environmental data;
acquiring a current first location of the device, and determining a second location based on the first location, wherein the first location is one of the target locations, and the second location is a location among the target locations other than the first location, and a predetermined condition is satisfied between the second location and the first location; and
based on the second location, determining second key data from the first key data, and storing the second key data in a preset database.

2. The method of claim 1, wherein the preset database is a spatial database.

3. The method of claim 2, wherein storing the second key data in the preset database comprises:
serializing the second key data and storing the serialized second key data in the preset database.

4. The method of claim 1, wherein determining first key data corresponding to the environmental data comprises:
obtaining at least one of a movement distance, a movement time, and a rotation angle corresponding to the device, and determining the first key data corresponding to the environmental data based on at least one of the movement distance, the movement time, and the rotation angle.

5. The method of claim 1, wherein determining the second location based on the first location comprises:
obtaining a distance between each of the target locations, except the first location, and the first location; and
determining one of the target locations whose distance from the first location is greater than a preset threshold as the second location.

6. The method of claim 1, wherein determining the second location based on the first location comprises:
obtaining a first time and a plurality of second times, wherein the first time is a time when the device arrives at the first location, and the second times are times when the device arrives at the target locations other than the first location; and
determining an interval between each of the second times and the first time, and determining one of the target locations corresponding to one of the intervals greater a preset threshold as the second location.

7. The method of claim 1, further comprising, after storing the second key data in a preset database,
determining third key data from the second key data when the device is detected to be at the second location; and
obtaining the third key data from the preset database, and generating a local map corresponding to the second location based on the third key data.

8. A device comprising:
one or more processors; and
a memory coupled to the one or more processors, the memory storing programs that, when executed by the one or more processors, cause performance of operations comprising:
during map construction by the device, acquiring environmental data collected when the device is at different target locations;
determining first key data corresponding to the environmental data;
acquiring a current first location of the device, and determining a second location based on the first location, wherein the first location is one of the target locations, and the second location is a location among the target locations other than the first location, and a predetermined condition is satisfied between the second location and the first location; and
based on the second location, determining second key data from the first key data, and storing the second key data in a preset database.

9. The device of claim 8, wherein the preset database is a spatial database.

10. The device of claim 9, wherein storing the second key data in the preset database comprises:
serializing the second key data and storing the serialized second key data in the preset database.

11. The device of claim 8, wherein determining first key data corresponding to the environmental data comprises:
obtaining at least one of a movement distance, a movement time, and a rotation angle corresponding to the device, and determining the first key data corresponding to the environmental data based on at least one of the movement distance, the movement time, and the rotation angle.

12. The device of claim 8, wherein determining the second location based on the first location comprises:
obtaining a distance between each of the target locations, except the first location, and the first location; and
determining one of the target locations whose distance from the first location is greater than a preset threshold as the second location.

13. The device of claim 8, wherein determining the second location based on the first location comprises:
obtaining a first time and a plurality of second times, wherein the first time is a time when the device arrives at the first location, and the second times are times when the device arrives at the target locations other than the first location; and
determining an interval between each of the second times and the first time, and determining one of the target locations corresponding to one of the intervals greater a preset threshold as the second location.

14. The device of claim 8, wherein the operations further comprise, after storing the second key data in a preset database,
determining third key data from the second key data when the device is detected to be at the second location; and
obtaining the third key data from the preset database, and generating a local map corresponding to the second location based on the third key data.

15. A non-transitory computer-readable storage medium storing instructions that, when executed by at least one processor of a device, cause the at least one processor to perform a method for detecting speaking behavior, the method comprising:
during map construction by the device, acquiring environmental data collected when the device is at different target locations;
determining first key data corresponding to the environmental data;
acquiring a current first location of the device, and determining a second location based on the first location, wherein the first location is one of the target locations, and the second location is a location among the target locations other than the first location, and a predetermined condition is satisfied between the second location and the first location; and
based on the second location, determining second key data from the first key data, and storing the second key data in a preset database.

16. The non-transitory computer-readable storage medium of claim 15, wherein the preset database is a spatial database.

17. The non-transitory computer-readable storage medium of claim 16, wherein storing the second key data in the preset database comprises:
serializing the second key data and storing the serialized second key data in the preset database.

18. The non-transitory computer-readable storage medium of claim 15, wherein determining first key data corresponding to the environmental data comprises:
obtaining at least one of a movement distance, a movement time, and a rotation angle corresponding to the device, and determining the first key data corresponding to the environmental data based on at least one of the movement distance, the movement time, and the rotation angle.

19. The non-transitory computer-readable storage medium of claim 15, wherein determining the second location based on the first location comprises:
obtaining a distance between each of the target locations, except the first location, and the first location; and
determining one of the target locations whose distance from the first location is greater than a preset threshold as the second location.

20. The non-transitory computer-readable storage medium of claim 15, wherein determining the second location based on the first location comprises:
obtaining a first time and a plurality of second times, wherein the first time is a time when the device arrives at the first location, and the second times are times when the device arrives at the target locations other than the first location; and
determining an interval between each of the second times and the first time, and determining one of the target locations corresponding to one of the intervals greater a preset threshold as the second location.
